(19) United States
(12) Patent Application Publication
(10) Pub. No.: US 2015/0103998 A1
(43) Pub. Date: Apr. 16, 2015

(54) Dialing Management System and Method

(71) Applicant: 21st Century Insurance and Financial Services, Inc., Wilmington, DE (US)

(72) Inventors: John Rosandich, Haddonfield, NJ (US); Mark Duchene, Bear, DE (US); Glenn Catarious, Pennsburg, PA (US)

(73) Assignee: 21st Century Insurance and Financial Services, Inc., Wilmington, DE (US)

(21) Appl. No.: 14/514,864

(22) Filed: Oct. 15, 2014

Related U.S. Application Data
(60) Provisional application No. 61/891,394, filed on Oct. 15, 2013.

(51) Int. Cl. H04M 3/51

(52) U.S. Cl. CPC H04M 3/5158
USPC 379/266.01

(57) ABSTRACT

A system and method handling and sorting calls includes maintaining leads in a database, segregating the leads based on type, performing automated calls for each of a first stream of leads, and queuing the second stream of leads in the list manager application to provide a newest available lead to a user interfacing with the list manager application. The user initiates a call via the list manager application to the newest available lead, and transfers the call to a sales representative when the newest available lead indicates an interest to the user via a telephone conversation that a purchase may be desired, or ends the call when the newest available lead indicates no interest, there is no answer for the call, or there is no call being completed.

### CROSS-REFERENCE TO RELATED APPLICATIONS

This application claims the benefit of U.S. Provisional Patent Application No. 61/891,394, filed on Oct. 15, 2013, which is hereby incorporated in its entirety herein by this reference.

### BACKGROUND OF THE DISCLOSURE

In certain markets, direct marketing via telephone to possible customers is carried out on a regular basis. In the past, marketers of such services enlisted the assistance of automated calling systems to dial telephone numbers of possible customers, which are sometimes referred to as leads. When placing such a call, the automated system may wait until a person answers the telephone on the other end of the line, and then route the call to a customer service representative.

Legislation and regulatory changes have affected the types of telephone numbers that can be called using automated systems. The Telephone Consumer Protection Act (TCPA), under the associated rules, dictates that wireless phone numbers of possible customers cannot be called by automated systems unless prior, express, written consent by the telephone owner has been provided.

In light of the new regulations, marketing companies cannot use their existing lists of leads because compliance with the regulations cannot be ensured.

### BRIEF SUMMARY OF THE DISCLOSURE

The invention provides new measures that can be taken by a telephone marketing entity to secure prior express written consent during a telephone marketing campaign, for example, an insurance quoting process, and also provides a new dialing methodology, which can be implemented when dialing wireless telephone number leads without prior express written consent (PEWC). The term “wireless,” as used herein, generally refers to any telephone number assigned to a paging service, cellular telephone service, specialized mobile radio service, or other radio common carrier service, or any service for which the called party is charged for the call. In one embodiment, a lead management data vendor can filter out non-consenting wireless phone leads from the feeds being delivered to their customer's predictive dialer system. These leads will be delivered to a custom list manager web application in real-time. Users may log into this application using a remote access application such as Citrix® or a virtual private network (VPN) from where the filtered leads can be retrieved, for example, manually or one at a time. A user of the system may then have the ability to click-to-dial each lead via an appropriate VoIP solution such as an Avaya soft phone. From within the same system, the user can dispose of a call and click-to-end each call placed to the applicable leads. These and other aspects and features of the invention are described in further detail below.

### BRIEF DESCRIPTION OF THE SEVERAL VIEWS OF THE DRAWINGS

FIG. 1 is a flowchart in accordance with the disclosure.

FIG. 2 is a block diagram for a user call handling process in accordance with the disclosure.

FIG. 3 is a process flow diagram for a dialing system in accordance with the disclosure.

FIG. 4 is flowchart for a call handling process in accordance with the disclosure.

FIGS. 5-7 are sample user interfaces for a list manager application in accordance with the disclosure.

### DETAILED DESCRIPTION OF THE INVENTION

The present disclosure is directed to a call handling and sorting system that complies with regulations placing restrictions on the types of calls that can be made by an automated system. Specifically, the disclosure relates to a system in which the types of telephone lines present in a list of leads are sorted based on the type of line that is called, and data is created and tracked to update the list when additional and relevant information becomes available. In one disclosed embodiment, a list of leads from a vendor or aggregator entity is separated into three categories. A first category is land lines, which are available for automated calling methods. A second category includes wireless telephone lines for which written authorization for follow-up or new calling is on file or otherwise has been provided to the calling entity. The third category includes wireless lines for which no authorization for automated calling exists or has been secured. For those lines belonging to the third category, in-person calls can be performed.

The disclosure provides a system, method and process for segregating leads lists into these three categories such that manual calling can be performed for those leads that are ineligible for automatic calling. In one disclosed embodiment, the lines belonging to the third category are automatically and continually sorted in a live interface accessible by representatives of a caller entity (users) that places the calls. These users can access an online interface with a lead sorting application, and from within the application, place calls to the appropriate leads in person. Depending on the disposition of the call, the users may either terminate the call or transfer the call to a customer service representative. The disclosed system further provides the capability of updating the leads list, in real time, to reflect the disposition of each lead call for future reference.

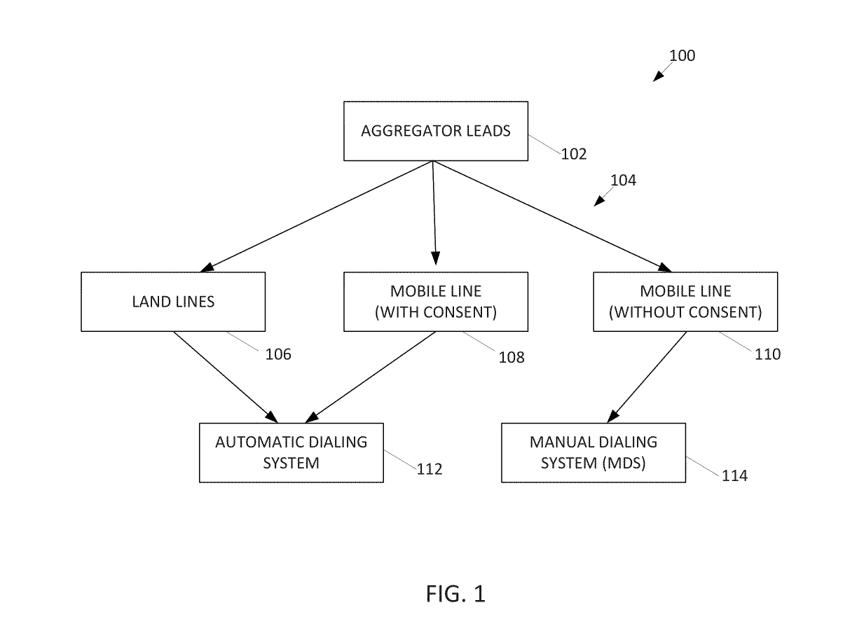

A block diagram for a lead segregation system 100 is shown in FIG. 1. In this embodiment, an aggregated list of leads 102 is compiled. The aggregated list of leads 102 may include many different types of telephone numbers, which include lines that can be called both automatically or manually. A sorting process 104 separates the aggregated list entries into a land lines category 106, which includes land line telephone lines, an automated wireless lines category 108, which includes wireless lines for which authorization for automated calling exists, and an in-person wireless lines category 110, for which no authorization or automated calling exists. The determination of whether a wireless line has an authorization on file, which authorizes automated calling, can be made by any appropriate means, for example, by interrogation and cross-referencing of the wireless line with a database containing a list of authorized numbers for automated calling. In one embodiment, a first determination is made for each entry in the aggregated list 102 to distinguish land lines from wireless lines, and a second determination is made as between the wireless lines to separate the authorized from the in-person wireless lines. Although these categorizations are discussed here, it is contemplated that alternate categorization rules and/or parameters may be used. For example, resource limitations and other factors may be used to categorize the leads such that the resulting functions may lead to manual calling of numbers categorized in the land lines category 106 and the automated wireless lines category 108.

In the case of the land lines 106 and the authorized wireless lines 108, the system 100 may route those leads as a first stream of leads to an automated calling process 112 for follow up. In the case of the in-person wireless lines 110, a second stream of leads may be forwarded to a manual dialing solution (MDS) 114, as is described below. Alternative arrangements are also contemplated. For example, wireless lines for which a PEWC has been obtained may also be routed to the manual dialing solution (MDS) depending on the results of the sorting process (such as a found match for a particular customer or contact) or the availability of customer representatives.

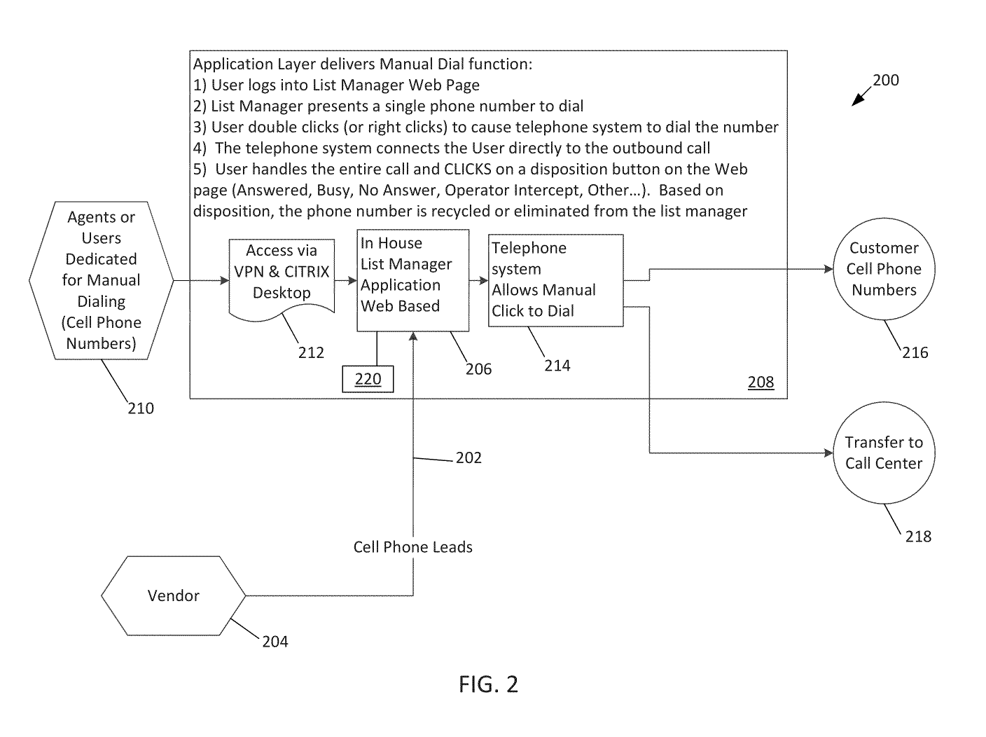

A flowchart for a manual calling system 200 is shown in FIG. 2. In this embodiment, information that includes wireless leads 202 requiring manual calling is provided by a vendor 204 into an in-house list manager application 206. The list manager application 206 may be a non-transitory, computer-executable application operating within a computer framework operating under the control, as relevant to the present disclosure, of a provider of services that is conducting the telephone marketing campaign.

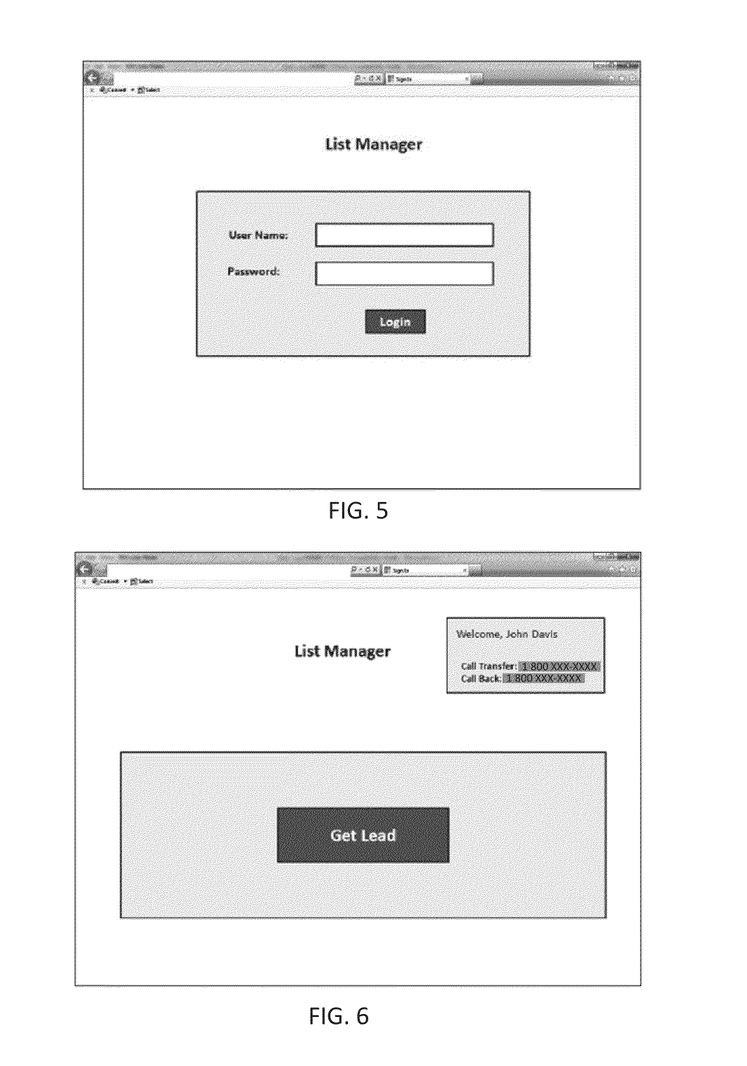

In the illustrated embodiment, a team of system users accesses the list manager application 206 via an appropriate interface 212. In the illustrated embodiment, the interface can be embodied as a VPN connection, a virtual desktop, or other interface, but any appropriate interface may be used. FIG. 5 illustrates a sample logon interface presented to the user upon logon to the list manager application 206. As shown in FIG. 5, each user may enter a user name and password to gain entry into the list manager application 206.

Within the list manager application 206, certain users 210, for example, supervisors with particular access rights from within the population of users 210, have access to the wireless leads 202 provided by the vendor 204. In general, the users can place calls using telephone leads from within the list. The supervisor users 210 may also update or alter the list depending on the disposition of the calls placed. Non-supervisor users 210 may be assigned leads from the wireless leads 202 for placing successive calls. For placing calls on the list, the users 210 may use a telephone client application 214, for example, an Avaya® application that allows for manual calling from within a computer interface. Upon completion of the call, the number called may be transferred to a list or computer database of customer wireless line phone numbers 216, or may alternatively be transferred to another call center 218, for example, if the person answering the call requires further information or assistance.

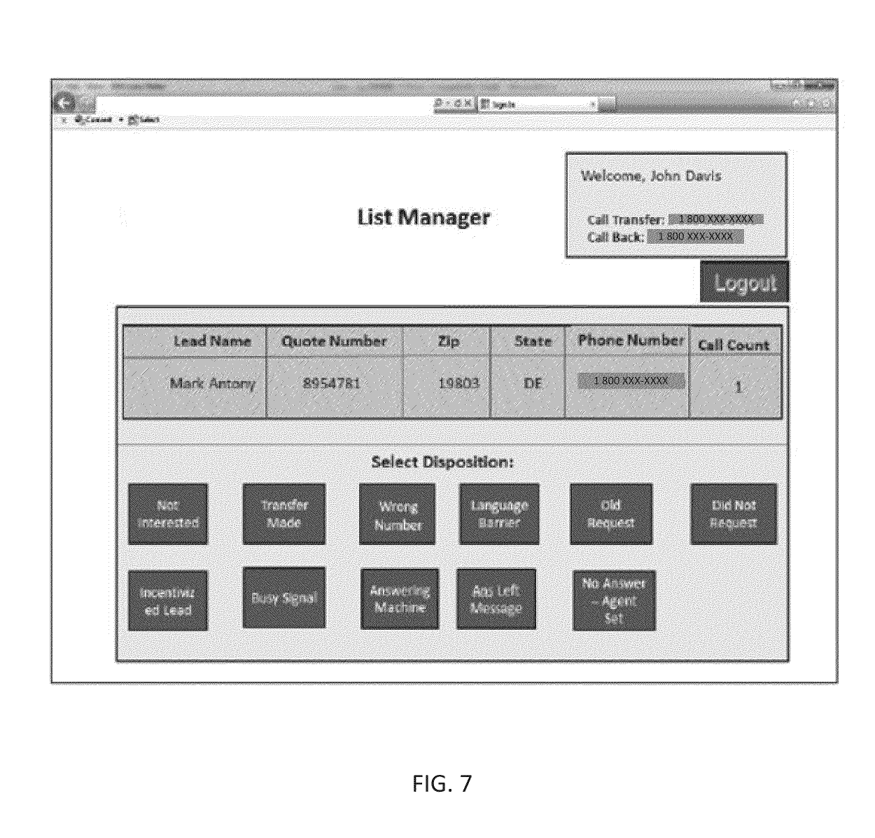

When operating the list manager application 206, a user 210 may first log into the system to access the information therein and for placing calls. The list manager application may present to the user at least one telephone number from the list of wireless leads 202, which the user may call. A sample user interface for retrieving a lead by a user is shown in FIG. 6. As shown in the interface, the user may select a “Get Lead” function icon to retrieve a lead. The name of the user and other calling information such as the call transfer number and call back number can also be shown in this interface for user reference during a session. The user may then be telephonically connected directly with the outgoing call placed. In one embodiment, the user may manually retrieve a telephone number with one click of an appropriate icon in a user interface of the application (see FIG. 6), and then place a call, again by a single click of an appropriate user interface icon. The user may then either handle the entire call or, alternatively, transfer the call to another person at a call center where the substantive portion of the call conversation may be carried out. Various call dispositions can be selected by the user during the call. In one exemplary user interface, as shown in FIG. 7, the name of a lead and other information about the lead such as quote number, zip code, state, phone number, and past call count, are provided to the user during the call. Also provided to the user during the call are options for call disposition including the caller not being interested, transferring the call to a call center, reaching a wrong number, encountering a language barrier, meeting an expired (old) request, or a false request for the call by the lead, having an incentivized lead, getting a busy signal, reaching an answering machine, leaving a message, or getting no answer. These and other options may be presented as clickable icons to the user during the call.

Whether a call is completed or not, upon final disposition of the call, the telephone number used to place the call may be recycled or eliminated from the list depending on the nature and disposition of the call. During or after the calls are placed and disposed, the system may track various statistics of the call including response time, call duration, call disposition, substantive information discussed with the person answering the call, date and time of the call, the telephone number, the number of times a particular lead was called, and other information. Such information may be collected and stored in the system 200 within a database 220 associated with the list manager application 206. Information from the database 220 may be compiled in reports and/or accessed in real time during calls.

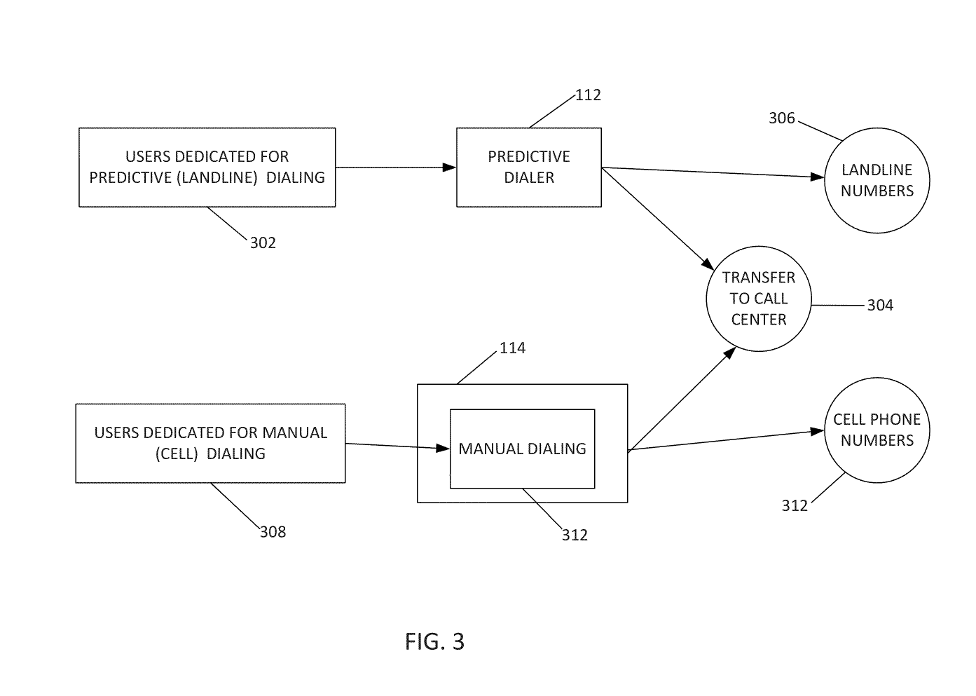

An integrated system for dialing leads 300 is shown in FIG. 3. The embodiment of this Figure discloses a system for addressing different types of leads. Specifically, the system includes both automatic dialing systems 112 (also see FIG. 1) as well as manual calling systems 114 (also see FIG. 1). As shown, the system includes dedicated teams of customer service group representatives. Representatives charged for automatic calling may interface with and maintain an automated calling system 112. The automated calling system may operate based on known leads that are amenable to automated calling such that, when a call is answered, the representatives 302 supervising the automated call process may handle the call, or transfer the call to another person at a centralized call center 304 and, optionally, update an appropriate database to reflect the disposition of each call, for example, in a database that tracks land line numbers 306.

A second team of representatives 308 dedicated for manually dialing numbers may interface with a manual dialing solution (MDS) 114. One example of such an arrangement is the system 200 previously described and shown in FIG. 2. In the embodiment of FIG. 3, a manual dialing methodology 310 to place calls to leads is shown. As in the automatic dialing system 112, the representatives overseeing the manual calling process 114 may deal directly with the calls when successful, or transfer them to the centralized call center 304, or to a different call center, and update an appropriate database 312. Of note is that the databases 306 and 312 may also be used in the future to “scrub” or cross-reference new leads coming in to determine whether they have already been contacted, as well as to note the past disposition, if any.

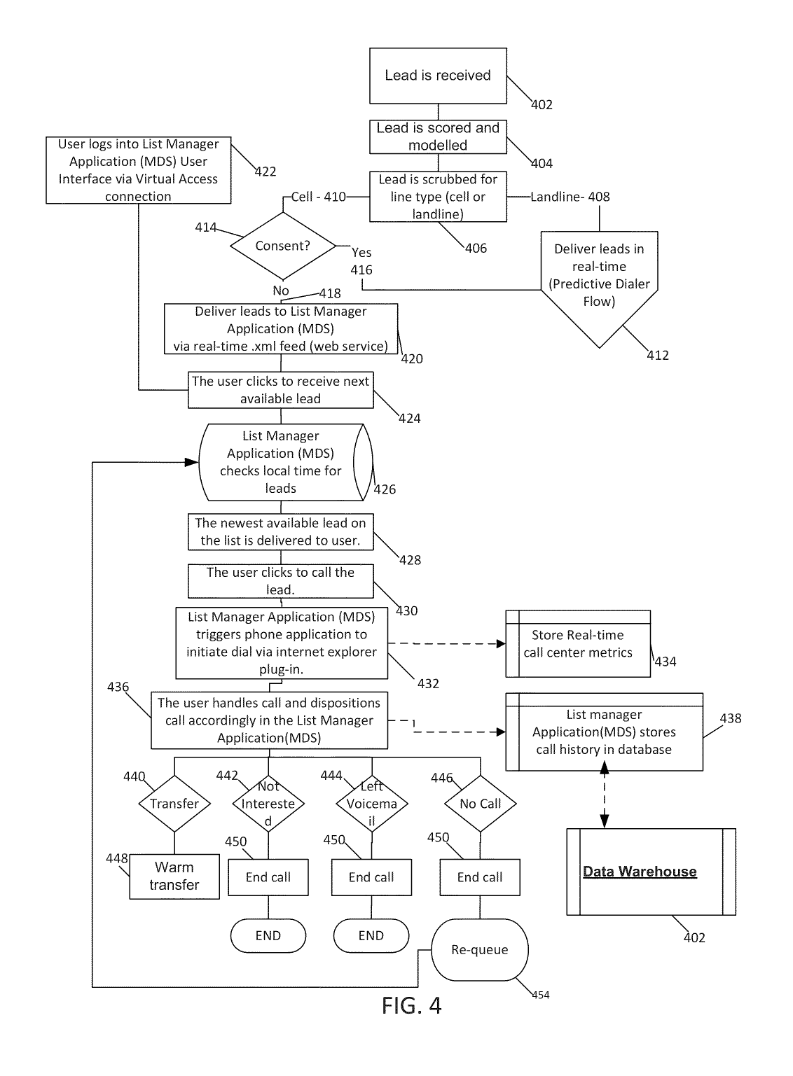

A flowchart for a method handling manual or automatic calling of leads is shown in FIG. 4. A vendor or aggregator compiles and delivers a list containing leads of unknown type, which are delivered to the system at process step 402. The leads may optionally be scored and modeled at step 404, which may include cross-checking the lead value against predetermined metrics. At a process 406, the list of leads is scrubbed to separate landlines 408 from wireless lines 410. Landlines are compiled into a new list or are otherwise delivered to an automated calling system 412. Wireless lines are cross referenced with a database containing those lines that can be automatically contacted at a scrubbing process 414. Those wireless lines that can be automatically contacted are routed to the automated calling system 412.

The lines that cannot be automatically contacted 418 are delivered to a list manager application 420, for example, the list manager 206 (FIG. 2). Concurrently, users log into the list manager framework at 422 and access list manager information provided by the list manager at an interface at 424. Accessing the list manager framework can be accomplished by any appropriate method, for example, using a remote access application such as Citrix® or a virtual private network (VPN). When placing a call, the list manager may check for the lead's local time at 426, sort the leads to prioritize new leads at 428, and provide the user with an option to place an in-person call to the lead at 430. Upon placing the call, the list manager activates an appropriate computer-based telephone application to connect the user with the lead over a live telephone line at 432, and records data indicative of the actions taken and the call disposition at this time with a real-time event recorder 434.

When the user is connected on the call, the user handles the call at 436 and the list manager stores a call history in a database at 438. At call completion, the user selects an appropriate disposition that reflects the nature of the call between a successful sale at 440, that the person called is not interested in a sale at 442, that a message was left at 444, in the case no answer was received, or that the call was not completed and no message was left at 446.

When a lead shows interest in buying a policy, which is indicated as a “sale” at 440, the user may transfer the call to a customer service representative to complete the sale transaction at 448 (warm transfer) or, alternatively, the user may complete the transaction. A warm transfer can be carried out by first entering into a conference call between the user, customer, and service representative, and then exiting the conference call while maintaining the connection between the customer and the service representative. When there is no interest in a sale at 442, or when a message is left at 444, the user terminates the call at 450 and no further action is taken. Other situations in which the call is terminated with no further action taken can include a wrong number, a language barrier existing with the caller, an outdated request, and others. When the call is not completed, the user terminates the call at 450 and then optionally performs a check as to whether that particular number was attempted before. Depending on the age of the lead, i.e., the time for which the lead has been in the call list, and depending on the number of attempts already made, the particular lead may be re-queued at 454 by returning the lead to the list manager 426. If multiple unsuccessful attempts have been made, e.g., more than 4, the lead may be retired, after which no action is taken. In the illustrated embodiment, a lead is retired when 4 attempts have been made within a 72-hour period. Other time periods or predetermined metrics may be used to retire or sort leads.

Various other features can be used. For example, the ability to record calls and to monitor calls between users, call centers and third parties may be available for quality control and training purposes. Moreover, the calls may be conducted only within specified times, for example, between 9 AM and 8 PM, Monday through Saturday. The local time for the lead may be determined by the zip code of the lead's address.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for handling and sorting calls using a non-transitory, computer executed list manager application, the method comprising:
receiving a plurality of leads from a vendor into a call management system;
adding, storing and maintaining the plurality of leads into a non-transitory database, the plurality of leads containing at least two types of leads wherein a first type of leads contains landline numbers and a second type of leads contains cellular phone numbers;
automatically segregating the first and second types of leads into two streams, a first stream that includes the first type of leads being provided to an automatic call center, and a second stream of leads being provided to a list manager application that is computer executable;
performing automated calls for each of the first stream of leads;
queuing the second stream of leads in the list manager application;
providing a newest available lead to a user interfacing with the list manager application;
initiating a call via the list manager application to the newest available lead; and
transferring the call to a sales representative, when the newest available lead indicates an interest to the user via a telephone conversation that a purchase may be desired, or
ending the call when the newest available lead indicates no interest, there is no answer for the call, or there is no call being completed.

2. The method of claim 1, further comprising re-queuing the lead used for the call when there is no answer to the call.

3. The method of claim 2, wherein the lead is re-queued a maximum of four times.

4. The method of claim 1, wherein each lead contains a name, telephone number, and street address information associated with the lead.

5. The method of claim 1, wherein automatically segregating the first and second types of leads is accomplished in the list manager application by automatically cross-referencing the plurality of leads with known lists of landline and cellular telephone numbers that exist and are maintained periodically within the database using the list manager application operating within the computer when the plurality of leads is received from the vendor.

6. The method of claim 1, further comprising a real-time event recorder associated with the list manager application, wherein the real-time event recorder operates to record metrics associated with the call when the call is initiated.

7. The method of claim 1, further comprising a scoring module operating to score a value of each of the plurality of leads against predetermined metrics when the plurality of leads is received from the vendor.

8. A method for handling and sorting calls using a non-transitory, computer executed list manager application, the method comprising:
receiving a plurality of leads from a vendor into a call management system;
adding, storing and maintaining the plurality of leads into a non-transitory database;
automatically selecting from the plurality of leads a first set of leads, which are provided to an automatic call center, and a second set of leads, which are provided to a computer-executable list manager application;
performing automated calls for each of the first set of leads;
assigning from the second set of leads a newest available lead to a user of the list manager application for placing a call;
initiating the call, via the list manager application using the newest available lead; and
transferring the call to a sales representative, when the newest available lead indicates an interest to the user via a telephone conversation that a purchase may be desired, or
ending the call when the newest available lead indicates no interest, there is no answer for the call, or there is no call being completed.

9. The method of claim 8, wherein the plurality of leads contains two types of leads, a first type of leads containing telephone numbers that can be called by an automated system, and a second type of leads contains telephone numbers that cannot be called by an automated system and require calling by a person.

10. The method of claim 8, further comprising re-queuing the lead used for the call when there is no answer to the call.

11. The method of claim 10, wherein the lead is re-queued a maximum of four times.

12. The method of claim 8, wherein each lead contains a name, telephone number, and street address information associated with the lead.

13. The method of claim 8, wherein automatically segregating the first and second sets of leads is accomplished in the list manager application by automatically cross-referencing the plurality of leads with known lists of landline and cellular telephone numbers that exist and are maintained periodically within the database using the list manager application operating within the computer when the plurality of leads is received from the vendor.

14. The method of claim 8, further comprising a real-time event recorder associated with the list manager application, wherein the real-time event recorder operates to record metrics associated with the call when the call is initiated.

15. The method of claim 8, further comprising a scoring module operating to score a value of each of the plurality of leads against predetermined metrics when the plurality of leads is received from the vendor.

16. A call handling and sorting system, comprising:
a call management system disposed to receive a plurality of leads from a vendor, the call management system being configured to place calls either automatically or manually based on the leads;
a database existing on non-transitory computer media, the database being configured for accepting, storing and maintaining the plurality of leads;
an automatic call center associated to receive leads from the database and place automatic telephone calls to the leads received;
a list manager application associated with the database;
a lead segregation module operating with computer executable instructions to segregate the plurality of leads into two streams, a first stream that includes the first type of leads, which is provided to the automatic call center, and a second stream of leads, which is provided to the list manager application that is computer executable;
wherein the list manager application is configured to:
queue the second stream of leads in the list manager application;
provide a newest available lead to a user interfacing with the list manager application;
initiate a call via the list manager application to the newest available lead; and
transfer the call to a sales representative, when the newest available lead indicates an interest to the user via a telephone conversation that a purchase may be desired, or
end the call when the newest available lead indicates no interest, there is no answer for the call, or there is no call being completed.

17. The call handling and sorting system of claim 16, wherein each lead is stored in the database as an identifiable record that contains at least a name, telephone number, and street address information associated with the lead.

18. The call handling and sorting system of claim 16, wherein the lead segregation module is configured to automatically segregating the first and second types of leads by automatically cross-referencing the plurality of leads with known lists of landline and cellular telephone numbers that exist and are maintained periodically within the database using the list manager application operating within the computer when the plurality of leads is received from the vendor.

19. The call handling and sorting system of claim 16, further comprising a real-time event recorder associated with the list manager application, wherein the real-time event recorder operates to record metrics associated with the call when the call is initiated.

20. The call handling and sorting system of claim 16, further comprising a scoring module operating to score a value of each of the plurality of leads against predetermined metrics when the plurality of leads is received from the vendor.
